(19) United States
(12) Patent Application Publication
(10) Pub. No.: US 2014/0259686 A1
(43) Pub. Date: Sep. 18, 2014

(54) Pocket Safety Cutter

(71) Applicant: Pacific Handy Cutter, Inc., (US)

(72) Inventors: Joseph P. Garavaglia, Newport Beach, CA (US); Markus Gropl, Huntington Beach, CA (US); Brandon L. Spoelstra, Costa Mesa, CA (US); Mark Marinovich, Rancho Santa Fe, CA (US)

(21) Appl. No.: 13/843,520

(22) Filed: Mar. 15, 2013

(51) Int. Cl. B26B 5/00; B26B 1/04

(52) U.S. Cl. CPC B26B 5/003; B26B 1/04
USPC 30/156; 30/161

(57) ABSTRACT

A pocket knife (or pocket safety cutter) having a housing (or handle) and a folding/blade holder portion includes or is configured with one or more of, for example: a blade change mechanism with multiple safety features, a locking mechanism (for the folding/blade holder portion), and independently operable protective guards (for the folding/blade holder portion).

### CROSS-REFERENCE TO RELATED APPLICATIONS

This application is related to U.S. Design patent application Ser. No. ______, entitled “Cutter Apparatus Body” filed herewith, which is hereby incorporated by reference.

### TECHNICAL FIELD

The present invention relates generally to cutters and, in particular, a pocket knife with a housing and a folding/blade holder portion.

### BACKGROUND ART

A great variety of knives, cutters, safety cutters, and cutter apparatuses are known. Features variously found in prior knives, cutters, safety cutters, and cutter apparatuses include mechanisms and devices facilitating, for example, blade deployment, blade locking, blade depth adjustment, blade change, or blade storage. Various ergonomic devices and apparatuses are also known.

It is known to provide a safety cutter with a guard (or guide) located a short distance from and facing a side of the cutting blade. See e.g., U.S. Pat. No. 5,386,632, U.S. Pat. No. 6,314,646 B1, U.S. Pat. No. D544,774 S, and U.S. Pat. No. 7,987,602 B2, which are hereby incorporated by reference.

Unfortunately, known safety cutters that include guards are often cumbersome, difficult or tedious to operate, or lacking in or obstructive of features that might otherwise be incorporated into a versatile state-of-the art cutter. Cutters with replaceable blades often present to an operator or user potential hazards associated with blade replacement, and can likewise be cumbersome or suffer from various safety and/or operational deficiencies.

It would be useful to be able to provide pocket knives (or pocket safety cutters) having a housing (or handle) and a folding/blade holder portion including or configured with one or more of, for example: a blade change mechanism with multiple safety features, a locking mechanism (for the folding/blade holder portion), and independently operable protective guards (for the folding/blade holder portion).

### SUMMARY OF THE INVENTION

In an example embodiment, a pocket knife includes a housing and a folding portion including a blade holder, the folding portion being repositionable in relation to the housing, the housing and the folding portion being configured such that a blade change operation can only be initiated when the knife is folded shut.

In an example embodiment, a pocket knife includes a housing and a folding portion configured to hold a blade, the folding portion being repositionable in relation to the housing, the housing and the folding portion being configured such that a blade change operation cannot be initiated when the knife is in an opened position.

In an example embodiment, a pocket knife includes a housing and a folding portion coupled to and repositionable in relation to the housing, the folding portion including a release member and a blade holder subassembly which is repositionable when the release member is actuated or triggered to a blade change position at which a blade positioned on the blade holder subassembly is partially covered until an additional action is performed to reposition a component of the blade holder subassembly in relation to one or more other components of the knife and/or the folding portion thereof.

In an example embodiment, a pocket knife includes a housing including an opening to a channel within the housing, a blade carrier within the channel, the blade carrier including one or more actuator portions that permit a user of the knife to slide the blade carrier along the channel, and a handle pivotally connected to the housing and configured to allow the housing to be pivoted away from the handle to an opened position, the handle including a biased engagement portion with a laterally extending protrusion that automatically locks the knife in the opened position until released.

In an example embodiment, a pocket knife includes a housing and a folding portion coupled to and repositionable in relation to the housing and configured for holding a blade, wherein the housing is formed with an integral spring portion including a lock member that engages the folding portion locking the folding portion in an opened position.

In an example embodiment, a pocket knife includes a housing and a blade carrier portion which is coupled to and configured to be foldable in relation to the housing to a closed position, the blade carrier portion including a slidably repositionable blade holder and protective guards independently operable for extending a blade secured to the blade holder when either of the protective guards is deployed.

In an example embodiment, a pocket knife includes a housing, a blade carrier portion coupled to and repositionable in relation to the handle, the blade carrier portion being foldable into the handle and including a blade holder configured for holding a blade, and one or more guards coupled to the blade carrier portion and repositionable for extending a blade from the blade carrier portion.

### BRIEF DESCRIPTION OF THE DRAWINGS

FIG. 1 is a perspective view of an example embodiment of a pocket knife shown unfolded into its opened position;

FIG. 2 is an exploded perspective view of the pocket knife of FIG. 1;

FIG. 3 is a left side view of the pocket knife of FIG. 1 shown folded into its closed position;

FIG. 4 is a left side view of the pocket knife of FIG. 1 shown with the folding portion thereof partially unfolded from the handle, the folding portion including a tape splitter at a bottom side distal portion thereof;

FIG. 5 is a left side view of the pocket knife of FIG. 1 shown unfolded into its opened position;

FIG. 6 is a close up perspective view showing an example handle/folding portion interface of the pocket knife of FIG. 1, the interface facilitating locking/engagement functionalities;

FIGS. 7 and 8 are left side partial views of the pocket knife of FIG. 1 showing extension of a blade responsive to repositioning of a slider along the folding portion;

FIG. 9 is a left side cross-sectional view of the pocket knife of FIG. 1 shown unfolded into its opened position;

FIG. 10 is a right side partial view of the pocket knife of FIG. 1 showing extension of a blade responsive to repositioning of a guard at the left side of the folding portion;

FIG. 11 is a left side partial view of the pocket knife of FIG. 1 showing extension of a blade responsive to repositioning of a guard at the right side of the folding portion;

FIG. 12 is a perspective partial view of the pocket knife of FIG. 1 showing a guard deployed at the right side of the folding portion, the guard including a laterally extending tab portion;

FIG. 13 is a perspective view of the left side guard and blade carrier/slider of the pocket knife of FIG. 1 showing engagement of the blade carrier/slider by the left side guard when the left side guard is deployed;

FIG. 14 is a perspective view of the right side guard and blade carrier/slider of the pocket knife of FIG. 1 showing engagement of the blade carrier/slider by the right side guard when the right side guard is deployed;

FIG. 15 is a perspective cross-sectional view of the folding portion showing the right side guard in its fully-retracted position and mechanically engaged at a lock/release element thereof by a retention surface of the folding portion;

FIG. 16 is a perspective cross-sectional view of the folding portion showing the right side guard in its fully-extended position;

FIG. 17 is a perspective cross-sectional view of the folding portion showing the left side guard positioned near its fully-retracted position;

FIGS. 18 and 19 show assembly of the folding portion securing a release member to a blade holder component of the folding portion at a base thereof;

FIG. 20 is a perspective view of the pocket knife of FIG. 1 showing the release member biased to a position that prevents a blade holder component/subassembly of the folding portion from repositioning in relation to a blade securing component/subassembly of the folding portion;

FIG. 21 is a cross-sectional view along lines 21-21 of FIG. 20 showing the release member engaged by a stop surface of the blade securing component/subassembly;

FIG. 22 is a perspective view of the pocket knife of FIG. 1 showing the release member repositioned to allow the blade holder component/subassembly to be repositioned in relation to a blade securing component/subassembly to perform a blade change operation;

FIG. 23 is a cross-sectional view along lines 23-23 of FIG. 22 showing the release member disengaged from the stop surface of the blade securing component/subassembly;

FIG. 24 is an end view of the pocket knife of FIG. 1 showing the blade holder component/subassembly pivotally repositioned in relation to a blade securing component/subassembly;

FIG. 25 is an end view of the pocket knife of FIG. 1 showing the blade holder component/subassembly repositioned to its blade change position at which a stop of the blade securing component/subassembly engages the release member preventing further pivoting of the blade holder component/subassembly away from the housing/handle;

FIG. 26 is a left side view of the pocket knife of FIG. 1 showing the blade holder component/subassembly in the blade change position at which a blade positioned on the blade holder subassembly is prevented from falling away from the blade holder subassembly by the blade securing component/subassembly; and

FIG. 27 is a left side view of the pocket knife of FIG. 1 showing an additional action (or step) of the blade change operation in which the slider is repositioned to access the blade.

### DISCLOSURE OF INVENTION

Devices and methods described herein involve pocket knives (or pocket safety cutters) having a housing (or handle) and a folding/blade holder portion including or configured with one or more of, for example: a blade change mechanism with multiple safety features, a locking mechanism (for the folding/blade holder portion), and independently operable protective guards (for the folding/blade holder portion).

Referring to FIGS. 1-9, in this example embodiment, a pocket knife 100 includes a housing (or folding portion) 102, a blade carrier 104, a spring 106, and a handle 108. The housing 102 includes an opening 109 to a channel 112 within the housing 102. The housing 102 and the handle 108 can be formed of various materials, for example, a thermoplastic that has high strength, rigidity, and impact resistance (e.g., Acrylonitrile butadiene styrene (ABS)), and by various processes (e.g., injection molding). The spring 106 can be provided in the form of a tension spring made, for example, of JIS G3506 High carbon steel wire rods.

In example embodiments, a pocket knife or other tool includes a housing (or folding portion) that is mechanically coupled to a handle. In this example embodiment, the handle 108 is pivotally connected to the housing 102 about a rivet 154 (e.g., bronze), and the handle 108 includes a recessed portion 156 sized to receive the housing 102 when the housing 102 is pivoted toward the handle 108. In this example embodiment, the handle 108 also includes an aperture 160 (e.g., at its base) through which a cord, string, lanyard, or the like can be attached to the pocket knife 100.

In example embodiments, the pocket knife 100 (that is, the handle 108 and portions of the housing 102) are shaped and sized to comfortably and safely fit in the user's pocket. In an example implementation, the pocket knife is a folding handle comprised of two plastic ABS halves sonically welded together and affixed to the zinc body by a rivet at the hinge point. In example embodiments, the housing 102 and the handle 108 are one or more of directly coupled (e.g., in direct contact with each other), indirectly coupled (e.g., coupled together by one or more intermediary coupling elements or components), continuously coupled (e.g., at least one portion of the housing 102 repositioning in relation to a continuous portion of the handle 108 as the at least one portion is repositioned in relation to the handle), and intermittently coupled (e.g., the housing 102 contacting or engaging different portions of the handle 108 at different times and/or without continuous coupling or surface contact as at least one portion of the housing is repositioned in relation to the handle).

The pocket knife 100 includes protective guards 110a and 110b (e.g., left and right guards formed as shown) which, in this example implementation, are slidably coupled (e.g., independently coupled) to the housing 102 at opposite sides thereof. The guards 110a and 110b can be formed of various materials, for example, a material made of or including a metal (or a metal alloy or a plastic) that has high strength and wear resistance (e.g., steel), and by various processes (e.g., progressive die stamping).

In this example embodiment, the guards 110a and 110b include or define portions of the channel 112, the housing 102 includes folding portions 114a and 114b (e.g., left and right side folding portions pivotally coupled by and about the rivet 154 as shown), and the handle 108 includes handle portions 161a and 161b (e.g., left and right side handle portions provided as shown) which are coupled to the folding portions 114a and 114b, respectively. In example embodiments, the left and right side folding portions 114a and 114b are one or more of directly coupled (e.g., in direct contact with each other), indirectly coupled (e.g., coupled together by one or more intermediary coupling elements or components), continuously coupled (e.g., at least one portion of the right side folding portion 114b repositioning in relation to a continuous portion of the left side folding portion 114a as the at least one portion is repositioned in relation to the left side folding portion 114a during a blade change operation), and intermittently coupled (e.g., the right side folding portion 114b contacting or engaging different portions of the left side folding portion 114a at different times and/or without continuous coupling or surface contact as at least one portion of the right side folding portion 114b is repositioned in relation to the left side folding portion 114a).

In example implementations, the folding portions 114a and 114b include or are provided with surfaces or portions configured to receive and support complementary surfaces or portions of the guards 110a and 110b, respectively, facilitating the aforementioned coupling of the guards 110a and 110b to the housing 102. In example implementations, one or both of the folding portions 114a and 114b support the blade carrier 104 depending upon whether the knife is in a blade deployment configuration (e.g., the housing 102 is unfolded to an opened position) or a blade change configuration (e.g., one of the portions 114a and 114b is pivoted away from the handle to a blade change position). In this example embodiment, the folding portion 114a is configured to support (e.g., slidably support) the blade carrier 104 (e.g., when the knife is in a blade deployment configuration) such that the blade carrier 104 is repositionable in relation to (e.g., along) the folding portion 114a. In this example embodiment, the folding portion 114b is configured to support (e.g., slidably support) the blade carrier 104 (e.g., when the knife is in either a blade deployment configuration or a blade change configuration) such that the blade carrier 104 is repositionable in relation to (e.g., along) the folding portion 114b. The blade carrier 104 and folding portions 114a and 114b (of the housing 102) can be formed of various materials, for example, a zinc alloy (e.g., Zamak 2), and by various processes (e.g., die cast).

The blade carrier 104 can include one or more actuator portions that permit a user of the pocket knife 100 to slide the blade carrier 104 along the channel 112. The one or more actuators include, for example, a combination of trigger and guard elements or components. The one or more actuator portions can include elements or components that are independently repositionable in relation to each other (e.g., deployable independent of each other) or in relation to other elements or components of the pocket knife. In this example embodiment, the one or more actuator portions include a slider (or button) 147, and the housing 102 includes a slot 149 through which the slider 147 extends. The blade carrier 104 and the slider 147 can be, but are not necessarily, integrally formed. In example embodiments, the one or more actuator portions include at least one guard (e.g., two guards that are independently repositionable).

Referring to FIGS. 3-5, 9 and 10, in operation, a user of the pocket knife 100 can utilize an engagement element 152 (e.g., a concave surface provided as shown) of the folding portion 114b to grasp and pivot (as denoted by the arrow 200) the housing 102 out of the recessed portion 156. The blade 138, biased by the spring 106, remains in its blade retracted position until the blade carrier 104 is slid (e.g., via an actuator) to the blade extended position. The spring 106 is operatively connected between the blade carrier 104 and the housing 102 such that the blade carrier 104 is biased along the channel 112 toward the blade retracted position. In this example embodiment, the spring 106 is connected, on opposite ends thereof, to a post 134 (on the blade carrier 104) and a post 136 (on the folding portion 114b). The blade 138 is mechanically coupled or secured to the blade carrier 104 (in various ways, and as described herein, depending upon the configuration of the knife and/or the stage of a blade change operation being performed). In this example implementation, when an actuator (e.g., the slider 147) after it has been deployed is released, the spring 106 immediately pulls the blade carrier 104 back to the blade retracted position.

In example implementations, one or more portions of the pocket knife include or are provided with surfaces or portions configured to facilitate an engagement between the housing 102 and the handle 108 (e.g., when the housing 102 is folded into the handle 108) that prevents deployment or use of one or more tools of the pocket knife. In example implementations, the engagement is such that no tool is deployed (or usable) or capable of being deployed when the folding portion is folded into the handle.

In example implementations, one or more engagements/interfaces between one or more of the folding portions 114a and 114b and the handle 108 are facilitated. The engagements/interfaces can be symmetrical (e.g., mirror images of each other) or otherwise. The engagements/interfaces can be provided, for example, on either or both sides of the housing 102 and/or on either or both inside portions of the handle 108.

The engagements/interfaces can include an engagement between the housing 102 and the handle 108 when the housing 102 is folded into the handle 108 to a closed position. Referring to FIGS. 1, 2, 5 and 6, in this example embodiment, the folding portion 114a includes a cylindrical recess 163, a curved track 164 with a detent channel 165 (e.g., redirecting outward from the curved recess as shown), and a curved track 170 (e.g., provided as shown between the curved track 164 and recess 163). The handle portion 161a includes or is provided with an engagement member 166 (e.g., a laterally extending protrusion on the inside of the handle 108) that travels around the track 164 and detents into the channel 165 when the housing 102 is pivoted into the handle 108 to the closed position (FIG. 3). Additionally or alternatively, the folding portion 114b and the handle portion 161b can be configured in this manner to provide closed position locking engagement for the pocket knife.

The engagements/interfaces can include an engagement between the housing 102 and the handle 108 when the housing 102 is folded away from the handle 108 to an opened/deployed position. Referring to FIGS. 5 and 6, in this example embodiment, the handle portion 161a includes or is provided with an engagement member 168 (e.g., a laterally extending protrusion on the inside of the handle 108) that travels around the curved track 170 and detents into the cylindrical recess 163 when the housing 102 is pivoted out of the handle 108 to its opened/deployed position. In this example embodiment, the handle portion 161a additionally includes contact surfaces (or areas) 171 and 172 (e.g., provided as shown at opposite ends of the curved track 170). Additionally or alternatively, the folding portion 114b and the handle portion 161b can be configured to provide opened/deployed position locking engagement for the pocket knife.

Example embodiments of pocket knives (or other tools) include a handle and a housing (e.g., including a blade carrier) that is repositionable in relation to the handle, the handle including a biased engagement portion with a lock member (e.g., an engagement element, component, or assembly) that engages an interior portion of the housing. Referring to FIG. 5, in this example embodiment, the handle 108 includes an integral spring portion 180 which defines an edge portion 181 of the handle 108, the edge portion 181 being partially separated from the handle by a slot 182 (e.g., formed or provided in the handle 108 as shown). The engagement member 168 can be released from its opened position locking engagement, for example, by manually lifting the integral spring portion 180 away from the cylindrical recess 163.

Thus, in an example embodiment, a pocket knife (or other tool) includes a housing including an opening to a channel within the housing, a blade carrier within the channel, the blade carrier including one or more actuator portions that permit a user of the knife to slide the blade carrier along the channel, and a handle pivotally connected to the housing and configured to allow the housing to be pivoted away from the handle to an opened position, the handle including a biased engagement portion with a laterally extending protrusion (e.g., an inwardly extending protrusion which is not visible to a user of the knife) that automatically locks the knife in the opened (or deployed) position until released. The pocket knife can include a spring operatively connected between the blade carrier and the housing such that the blade carrier is biased along the channel toward a blade retracted position. In example embodiments, the engagement portion engages with a complementary portion (e.g., a recess) of the housing to lock the pocket knife in the opened position. In example embodiments, the engagement portion engages a recessed portion of the housing that is not visible to a user of the pocket knife (independent of whether the knife is in the opened position or in a closed position) to lock the knife in the opened position. In example embodiments, the engagement portion is integrally formed with an edge of the housing. In example embodiments, the engagement portion is biased toward the housing by a portion of the handle (e.g., handle portion(s) including and/or adjacent to the spring portion 180) that receives the housing when the housing is pivoted toward the handle.

In example embodiments, the housing includes a guide portion, e.g., a curved recess/channel with end portions, such as provided by the curved track 170 and the contact surfaces 171 and 172, along (and/or within) which the engagement portion repositions when the housing is pivoted in relation to (e.g., toward) the handle. The guide portion can include a surface (e.g., an angled surface or other portion, such as the contact surface 171) that faces the engagement portion when the housing is in a closed position (within the handle) providing a mechanical resistance to the housing being moved (e.g., unfolded) from the closed position.

The one or more actuator portions can include one or more cut guards (or protective guards) such as, for example, a pair of cut guards that are repositionable (e.g., independently repositionable along opposites sides of the housing) and that are received within the handle when the housing is folded to a closed position. In example embodiments, the cut guards are (retracted and) received (e.g., entirely contained/received) within the handle when the housing is folded to a closed position.

Example embodiments of pocket knives (or other tools) include a housing (e.g., handle) and a folding portion (e.g., including a blade carrier) with a lock member (e.g., an engagement element, component, or assembly) that engages an interior portion of the housing locking the folding portion in its opened/deployed position (in relation to the housing) until released.

Thus, in an example embodiment, a pocket knife (or other tool) includes a housing (e.g., handle) and a folding portion coupled to and repositionable in relation to the housing and configured for holding a blade, wherein the housing is formed with an integral spring portion including a lock member that engages the folding portion locking the folding portion in an opened (deployed/unfolded) position (in relation to the housing). In example embodiments, the lock member is not visible to a user of the knife. In example embodiments, the integral spring portion defines (a portion of) an opening that receives the folding portion when the folding portion is repositioned (in relation to the housing) to a closed position. In example embodiments, the integral spring portion defines an edge portion of the housing, the edge portion being partially separated from the housing by a slot. In example embodiments, the lock member extends laterally toward the folding portion. In example embodiments, the integral spring portion is configured to bias the lock member toward the folding portion.

In example embodiments, the folding portion includes a guide portion, e.g., a curved recess/channel with end portions, such as provided by the curved track 170 and the contact surfaces 171 and 172, along (and/or within) which the lock member repositions when the folding portion is pivoted in relation to (e.g., toward) the housing. The guide portion can include a surface (e.g., an angled surface or other portion, such as the contact surface 171) that faces the lock member when the folding portion is in a closed position (within the housing) providing a mechanical resistance to the folding portion being moved (e.g., unfolded) from the closed position. In example embodiments, the folding portion includes a pair of cut guards configured to locate within the housing when the folding portion is moved to a closed position (e.g., folded into the housing).

Example embodiments of pocket knives (or other tools) include a blade carrier and one or more actuators and/or guards (e.g., actuators in the form of or including guards) operatively connected to the blade carrier. In example embodiments, the pocket knife includes at least one actuator configured to support a blade carrier (e.g., to allow a user to reposition the blade carrier 104 in relation to one or more portions of the housing 102). Referring to FIGS. 7-9, in this example embodiment, the guards 110a and 110b (via respective inside portions/surfaces thereof) support the blade carrier 104 during deployment (as denoted by the arrow 202) of the slider 147 extending the blade 138 from the housing 102. For tray cuts, the blade 138 can be activated by the slider 147 (e.g., a button) on the top surface of the knife.

In this example embodiment, the blade carrier 104 slidably interfaces with both the right side guard 110b and the right side folding portion 114b. Specifically, as shown in FIGS. 10 and 12, the blade carrier 104 includes a cantilevered member 130 (extending from the back side of the blade carrier 104), and the right side folding portion 114b includes or is provided with a channel 131 (e.g., as shown). Top and bottom edges of the cantilevered member 130 slidably interface with opposing sides of the channel 131 allowing the cantilevered member 130 to reposition along the channel 131 (e.g., when the blade carrier 104 is deployed). Referring additionally to FIG. 14, a lateral portion 132 of the cantilevered member 130 defines a recess 133 (between the cantilevered member 130 and the back side of the blade carrier 104), the recess 133 being configured to receive therein a rail (or tongue) 140b of the guard 110b. Accordingly, the blade carrier 104 is secured to the right side guard 110b independent of whether the blade carrier 104 is extended (or repositioned) along the right side guard 110b and also independent of the position of the left side guard 110a (in relation to the right side guard 110b). As shown in FIG. 14, in this example embodiment, a distal facing surface 141b (e.g., defined by a channel or opening of the right side guard 110b) drives the blade carrier 104 when the right side guard 110b is deployed via contact with the lateral portion 132 (of the cantilevered member 130). Referring to FIGS. 15, 16, 18 and 19, the right side guard 110b, in turn, slidably interfaces with and is coupled to the right side folding portion 114b, for example, by rails (or surfaces) 144b, 145b, 146b of the folding portion 114b adjacent to top and bottom edge portions of the guard 110b, thereby securing both the guard 110b and the blade carrier 104 to the folding portion 114b.

Referring to FIGS. 10, 12, 14, 18 and 19, in this example embodiment, the channel 131 (of the right side folding portion 114b includes a stop 153b, and the cantilevered member 130 includes a distal facing surface 129. The channel 131 is configured to receive the cantilevered member 130 therein and to allow the blade carrier 104 to reposition in relation to the housing 102. When the folding portions 114a and 114b are secured together and unfolded from the handle 108 to an opened position, independent of which actuator is deployed, a maximum amount or distance that the blade carrier 104 can be extended is defined or limited by contact between the distal facing surface 129 and the stop 153b. For a blade change operation during which the right side folding portion 114b is pivoted out of the handle 108 and the left side folding portion 114a remains secured within the handle 108 (discussed below in greater detail), either the slider 147 or the right side guard 110b can be used to distally reposition the blade carrier 104. Independent of whether the right side folding portion 114b is deployed with the left side folding portion 114a when the housing 102 is unfolded to the opened position, or without the left side folding portion 114a to facilitate a blade change operation, the right side guard 110b can be extended (e.g., in relation to the right side folding portion 114b during the blade change operation) until the distal facing surface 129 of the cantilevered member 130 is brought into contact with the stop 153b, thereby defining a fully extended or deployed position of the right side guard 110b.

Referring to FIG. 13, in this example embodiment, the left side guard 110a includes a laterally extending rail (or member) 142a. When the folding portions 114a and 114b are secured together, the rail 142a faces a blade held on the blade carrier 104. The rail 142a provides an interface along which the blade carrier (and blade) can reposition (in relation to the left side guard 110a) when the blade carrier is extended. Referring additionally to FIGS. 2 and 9, in this example embodiment, the blade carrier 104 includes (at the front side thereof) a distal post (or member) 150 and a proximal post (or member) 152. The posts 150 and 152 are configured to receive and support a blade (e.g., as shown), the blade being located adjacent to the front (i.e., blade holding) side of the blade carrier. As shown in FIG. 13, in this example embodiment, the distal edge 143a (on the rail 142a of the left side guard 110a) drives the blade carrier 104 when the left side guard 110a is deployed via contact with the surface 151 (of the distal post 150). In this example embodiment, the proximal post 152 is lower in profile than the distal post 150 (e.g., the proximal post 152 laterally extending from the front side of the blade carrier a distance slightly greater than the thickness of the blade), which accommodates movement (pivotal repositioning) of the right side folding portion 114b relative to the left side folding portion 114a. Referring to FIGS. 17-19, the left side guard 110a, in turn, slidably interfaces with and is coupled to the left side folding portion 114a, for example, by rails (or surfaces) 144a, 145a, 146a of the folding portion 114a adjacent to top and bottom edge portions of the guard 110a, thereby securing the guard 110a to the folding portion 114a.

Referring to FIGS. 13 and 17-19, in this example embodiment, the left side folding portion 114a includes a stop 153a, and the left side guard 110a includes a distal facing surface 141a (e.g., defined by a channel or opening of the guard 110a configured to receive the stop 153a and to allow the guard 110a to reposition in relation to the folding portion 114a). When the folding portions 114a and 114b are secured together and unfolded to the opened position, the left side guard 110a can be extended (e.g., in relation to the left side folding portion 114a) until the surface 141a of the guard 110a is brought into contact with the stop 153a, thereby (further or alternatively) defining a fully extended or deployed position of the left side guard 110a.

Example embodiments of pocket knives (or other tools) include a blade carrier and one or more actuators and/or guards (e.g., actuators in the form of or including guards). In example embodiments, the housing 102 and the one or more actuators and/or guards are one or more of directly coupled (e.g., in direct contact with each other), indirectly coupled (e.g., coupled together by one or more intermediary coupling elements or components), continuously coupled (e.g., at least one actuator/guard repositioning in relation to a continuous portion of the housing 102 as the at least one actuator/guard is deployed), and intermittently coupled (e.g., at least one actuator/guard contacting or engaging different portions of the housing 102 at different times and/or without continuous coupling or surface contact as the at least one actuator/guard is retracted in relation to the housing or a portion thereof).

In example embodiments, at least one of the actuators and/or guards includes an actuator guide that provides an interface (e.g., facilitating repositioning movements) for another actuator (e.g., an actuator or actuator assembly including a blade carrier and/or a blade). In example embodiments, the pocket knife includes an actuator guide configured to support a blade carrier (e.g., to allow a user to reposition the blade carrier 104 in relation to one or more portions of the housing 102).

In example embodiments, an actuator guide is provided by a pair of guards that are independently extendable in relation to a folding portion (or blade carrier portion) of the knife, and an interface between an actuator (e.g., a slider) and the actuator guide including one or more interference (or contact) points of, coupled to, and/or operatively connected to the actuator. By way of example, and referring to FIGS. 10 and 13, the left side guard 110a can be extended (pushed distally) independent of the right side guard 110b, with force imparted by the portion 143a to the portion 151 extending (as denoted by the arrow 204) the blade 138 as the left side guard 110a is pushed forward. Referring to FIGS. 11, 12 and 14, the right side guard 110b can be extended (pushed distally) independent of the left side guard 110a, with force imparted by the portion 141b to the portion 132 extending (as denoted by the arrow 206) the blade 138 as the right side guard 110b is pushed forward. Additionally, in this example implementation, the blade carrier 104 and the guards 110a and 110b are configured (via the contact interfaces described above) such that the guards retract with the blade carrier, but do not extend or reposition with the blade carrier when the slider is used to deploy the blade (due to the portions 151 and 132 being located distally in relation to the portions 143a and 141b, respectively). Moreover, in this example implementation, a single spring (e.g., the spring 106) or other biasing mechanism coupled to the blade carrier 104 is configured (in conjunction with the contact interfaces described above) to retract the blade carrier as well as any guard(s) deployed. Thus, in this example implementation, each guard contacts the slider from the back (in the interference points) pushing the slider when activated. The guards in turn are pulled back (retracted) by the slider when the spring causes the slider to retract.

In this example implementation, the guards 110a and 110b include laterally protruding tabs 111a and 111b (e.g., provided as shown) that provide additional engagement surfaces for deploying the guards. The laterally protruding tabs 111a and 111b are configured to reposition (after a deployed actuator is released) adjacent to portions 115a and 115b of the folding portions 114a and 114b, respectively. The portions 115a and 115b can be complementary to (and/or configured to face) the tabs 111a and 111b, respectively.

In example embodiments, a pocket knife includes a housing (e.g., a handle) and a folding portion having one or more guards (e.g., independently operable guards) configured to locate within the housing when the knife is folded shut. The guards can include one or more laterally protruding portions (e.g., tabs configured to facilitate guard activation) that locate within the housing when the folding portion is in a closed position and/or secured to the housing.

In operation, the blade 138 can also be activated by either of the left side guard 102a or the right side guard 102b for performing top cuts by right and left handed people, respectively. In this example implementation, either guard when slid forward pushes the blade carrier 104 forward, so it is not necessary to also deploy the slider 147. In this example embodiment, and as previously noted, the guards 102a and 102b additionally include protruding tabs 111a and 111b, respectively, which are configured to facilitate easy activation of the guard by a thumb. The guards 102a and 102b automatically retract and, in this example embodiment, have the same springback action (e.g., provided by the same biasing mechanism, such as the spring 106, or a shared biasing mechanism).

Additionally, in this example implementation, the housing 102 (specifically, the folding portion 114a thereof) includes or is provided with a tape splitter 128 (e.g., as shown). By way of example, the tape splitter 128 can be provided on, secured to, or integrally formed as part of the housing 102 (e.g., cast into the lower front of the left body half). In this example embodiment, the tape splitter 128 is below the guards 110a and 110b and proximally located in relation to the opening 109, so that tape can be cut when the housing 102 is in its opened position without exposing the blade, reducing the risk of accidental cuts. The tape splitter 128 can be, but is not necessarily, symmetrically positioned between the guards 110a and 110b (e.g., centered relative to the guards 110a and 110b in their respective fully retracted positions). The tape splitter 128 (e.g., in conjunction with the folding portion 114a) can be formed of various materials, for example, a zinc alloy (e.g., Zamak 2), and by various processes (e.g., die cast).

Referring to FIGS. 15-17, in this example implementation, the guards 110a and 110b include lock/release elements 190a and 190b (e.g., internal spring arms with friction fit tabs provided as shown), respectively, that interface with features of the body halves to prevent the guards 110a and 110b from sliding out unintentionally. In this example implementation, the folding portions 114a and 114b include retention surfaces 192a and 192b (e.g., friction fit raised interior portions provided as shown), respectively. The lock/release elements 190a and 190b are configured to engage with the retention surfaces 192a and 192b, respectively, when the guards 110a and 110b are retracted. In example embodiments, the lock/release elements 190a and 190b and the retention surfaces 192a and 192b are configured such that for each of the guards 110a and 110b no more than a predetermined amount of force imparted upon the guard is required to disengage the lock/release element from its retention surface.

Thus, in an example embodiment, a pocket knife (or other tool) includes a pocket knife including a housing (e.g., handle), and a blade carrier portion which is coupled to and configured to be foldable in relation to the housing to a closed position, the blade carrier portion including a slidably repositionable blade holder and protective guards independently operable for extending a blade secured to the blade holder when either of the protective guards is deployed. The protective guards can be configured to locate within the housing when the blade carrier portion is moved to the closed position. In example embodiments, the protective guards are positioned (e.g., entirely positioned) within the housing when the blade carrier portion is in the closed position and/or each include a laterally protruding tab. The blade carrier portion can include one or more repositionable components, such as the folding portions 114a and 114b, and the knife can be configured such that the repositionable components are locked or secured at a closed position (such as, for example, the knife configuration shown in FIG. 3, in which the guards 102a and 102b and the opening 109 are covered by, as well as secured within, the handle 108). In such example embodiments, no tool is deployed (or usable) or capable of being deployed when the folding portion is folded into the handle.

Thus, in an example embodiment, a pocket knife (or other tool) includes a handle, a blade carrier portion coupled to and repositionable in relation to the handle, the blade carrier portion being foldable into the handle and including a (slidably repositionable) blade holder configured for holding a blade, and one or more (protective) guards coupled to the blade carrier portion and repositionable (in relation to the handle) for extending a blade from the blade carrier portion. The one or more guards include, for example, a pair of protective guards that are independently extendable in relation to the blade carrier portion. In example embodiments, the one or more guards include a pair of protective guards that are completely contained within the handle when the blade carrier portion is in a closed position (e.g., folded into the handle). In example embodiments, the one or more guards each include a lock/release element configured to engage with a retention surface (or structure) of the blade carrier portion when the guard is (fully) retracted (e.g., to prevent the guard via friction/resistance from extending unintentionally). For example, the lock/release element and the retention surface can be configured such that no more than a predetermined (minimal) amount of force imparted upon the guard is required to disengage the lock/release element from the retention surface. In example embodiments, the blade carrier portion includes a tape splitter.

The blade carrier portion can include a slider (e.g., a button or other actuator) coupled to the blade holder and repositionable (e.g., along the blade carrier portion) for extending the blade from the blade carrier portion. In example implementations, the blade carrier portion is configured such that the one or more guards retract with the slider, that is, the guard(s) when previously extended, retract with the slider as the slider retracts. In example implementations, the blade carrier portion is configured such that the one or more guards retract with the slider, but do not extend or reposition with the slider when the slider is used to deploy the blade.

The blade carrier portion can include a spring (e.g., a single spring) (or other biasing element or component) coupled to the slider and configured to retract both the slider and the one or more guards. In example implementations, the blade carrier portion includes a biasing mechanism constituting a single spring configured to retract both the slider and the one or more guards. In the example embodiment described herein, the single spring is coupled to the slider biasing the slider to retract, but is not connected to the one or more guards.

In example implementations, one or more engagements/interfaces between the folding portions 114a and 114b are facilitated. The engagements/interfaces can be provided, for example, at a base portion of the housing 102 and/or on either or both of the folding portions 114a and 114b. Referring to FIGS. 18 and 19, in this example embodiment, the engagements/interfaces include surfaces of the folding portions 114a and 114b (e.g., surfaces defining and/or facilitating a circumferential interface) configured to reposition in relation to each other at a base portion of the knife (e.g., when the right side folding portion 114b is repositioned to a blade change position).

The engagements/interfaces can include an engagement (e.g., a locking engagement) between the folding portions 114a and 114b (e.g., facilitated when the housing 102 is folded into the handle 108 to a closed position). The engagements/interfaces can include an interface (e.g., facilitating movement of one the folding portions 114a and 114b relative to the other) that can only be activated when the housing 102 is in a particular configuration (e.g., when the folding portions 114a and 114b are reengaged after a blade change operation and folded back into the handle 108 to a closed position).

Referring to FIGS. 2 and 18-23, in this example embodiment, the pocket knife includes a folding portion (i.e., the folding portions 114a and 114b and the blade carrier 104) with a release member 220 configured to extend (e.g., as shown) from an opening 222 of the housing 102. The release member 220 can be provided in the form of a blade change tab. The release member 220 is secured between the folding portions 114a and 114b by the rivet 154. In this example embodiment, the release member 220 is configured to flex laterally (within the opening 222), and is rotationally fixed (by side portions of the opening 222) in relation to the right side folding portion 114b. The release member 220 can be a metal piece, such as a leaf spring. The release member 220 can be formed of various materials, for example, a material made of or including a metal (or a metal alloy or a plastic) that has high strength and wear resistance (e.g., SUS301 stainless steel), and by various processes (e.g., stamped).

In this example embodiment, the folding portions 114a and 114b (of the housing 102) are configured such that the release member 220 is positioned within an end portion of the housing 102 and is inaccessible by a user of the knife when the housing 102 is in the (deployed) opened position. In this example embodiment, the opening 222 is at a base portion 224 of the housing 102, and the left folding portion 114a and the left handle portion 161a include recesses 226a and 228a, respectively, which provide a visual indication of, and improve user access to, the release member 220 (e.g., when the housing 102 is folded into the handle in its closed configuration).

Referring to FIGS. 20 and 21, when the folding portions 114a and 114b are folded into the handle 108 to a closed position, the release member 220 is biased toward the left side folding portion 114a as shown, and a stop surface 116a of the folding portion 114a prevents movement (rotation) of the right side folding portion 114b relative to the left side folding portion 114a. Referring to FIGS. 22 and 23, when the release member 220 is laterally repositioned (as denoted by the arrow 208) toward the right side folding portion 114b, the stop surface 116a no longer prevents the right side folding portion 114b from pivotally repositioning relative to the left side folding portion 114a. Referring to FIGS. 24 and 25, after the release member 220 is actuated (deployed), the right side folding portion 114b is free to be repositioned relative to the left side folding portion 114a (an interface facilitating further pivotal movement of the folding portion 114b being activated once the release member 220, which is fixed in position in relation to portion 114b, repositions past the stop 116a when the portion 114b is initially pulled away from the handle 108). Once activated, the interface allows a user of the knife to pivot the right side folding portion 114b to a predetermined position (e.g., a blade change position) at which a stop surface 116b of the right side folding portion 114b comes into contact with the stop surface 116a of the left side folding portion 114a.

Example embodiments of pocket knives and other tools include a blade holder subassembly and a blade securing component. In this example embodiment, a blade holder subassembly (or component) 230 is provided by the right side folding portion 114b, the right side guard 110b, and the blade carrier 104, and a blade securing subassembly (or component) 232 is provided by the left side folding portion 114a and the left side guard 110a. Referring to FIGS. 26 and 27, after the release member 220 is deployed, the blade holder subassembly 230 is free to pivotally reposition (the aforementioned interface which facilitates such movement being activated once the release member 220 bypasses the stop surface 116b) relative to the blade securing component 232.

Example embodiments of pocket knives and other tools include one or more folding portions configured to support a component or assembly (e.g., an actuator/guard) during a blade change operation. In example embodiments, two folding portions (such as, for example, the folding portions 114a and 114b) support a blade carrier (such as, for example, the blade carrier 104) at opposite sides thereof, and are repositionable in relation to each other (e.g., during a blade change operation). In example embodiments, a folding portion (such as, for example, the folding portion 114b) supports an assembly (e.g., including one or more components such as the guard 110b and the blade carrier 104) during a blade change operation.

Example embodiments of pocket knives and other tools include or are configured to utilize one or more safety features in relation to initiating and/or performing a blade change operation. For example, a pocket knife can be configured (e.g., as described herein) such that a blade change operation can only be initiated from a safe or other predetermined configuration (e.g., a closed configuration) and/or such that a blade change operation cannot be initiated from a potentially unsafe or other configuration (e.g., an opened configuration).

Thus, in an example embodiment, a pocket knife (or other tool) includes a housing (e.g., handle) and a folding portion including a blade holder (or blade carrier), the folding portion being (coupled to and) repositionable in relation to the housing, the housing and the folding portion being configured such that a blade change operation (that includes, for example, replacing a blade on the blade holder with a new or different blade) can only be initiated when the knife is folded shut. In example embodiments, the folding portion includes a release member (or mechanism) that allows one or more components of the folding portion to reposition to allow a user of the knife to perform the blade change operation.

Thus, in an example embodiment, a pocket knife (or other tool) includes a housing (e.g., handle) and a folding portion configured to hold a blade, the folding portion being (coupled to and) repositionable in relation to the housing, the housing and the folding portion being configured such that a blade change operation (that includes, for example, replacing a blade on the blade holder subassembly with a new or different blade) cannot be (is prevented from being) initiated when the knife is in an opened (e.g., unfolded, fully opened) position. In example embodiments, the folding portion includes a release member (or mechanism) that is repositionable to allow one or more components of the folding portion to be repositioned by a user of the knife to perform the blade change operation. In example embodiments, the release member is a (spring-biased) blade change tab (e.g., laterally biased). In example embodiments, the release member is configured to flex laterally and/or is rotationally fixed in relation to one or more components of the folding portion (e.g., a blade holder subassembly thereof with respect to rotation about an axis parallel to a pivot axis of the subassembly). In example embodiments, the release member is positioned adjacent to an end portion of the housing (e.g., to which the folding portion is pivotally coupled) and is accessible by a user of the knife when the folding portion is in a (folded) closed position. In example embodiments, the release member is positioned within an end portion of the housing (e.g., to which the folding portion is pivotally coupled) and is inaccessible by a user of the knife when the folding portion is in the (deployed) opened position.

The housing and the folding portion can be configured, by way of example, such that the release member is accessible when the folding portion is folded to a closed position (or when the folding portion is repositioned at least a predetermined amount away from the opened position).

The housing and the folding portion can be configured, by way of example, such that the release member is not accessible when the folding portion is folded to the opened position (or when the folding portion is not repositioned at least a predetermined amount away from the opened position).

In example embodiments, the folding portion includes a blade holder subassembly configured to be repositionable in relation to one or more other components of the folding portion when the release member is actuated or triggered.

Referring to FIG. 26, in this example implementation, the blade holder subassembly 230 is (pivotally) repositionable in relation to the housing (i.e., handle 108) and in relation to one or more other component(s)/element(s) of the folding portion (i.e., the blade securing component 232) when the release member 220 is actuated or triggered. Additionally, in this example implementation, the blade holder subassembly 230 is repositionable, when the release member is actuated or triggered, to a blade change position at which a blade 138 positioned on the blade holder subassembly 230 is partially covered by the blade securing component 232 (to lessen the likelihood of the blade falling away from the blade holder subassembly) until an additional action (e.g., an action independent of the release member) is performed.

In example embodiments, the additional action includes repositioning a component of the blade holder subassembly in relation to a blade securing component/element of the knife. Referring to FIG. 27, in this example implementation, the blade securing component 232 is configured to remain mechanically engaged with the housing (i.e., handle 108) when the release member 220 is actuated or triggered, and the additional action includes repositioning (as denoted by the arrow 210) a component of the blade holder subassembly (i.e., the blade carrier 104/slider 147) in relation to the blade securing component. In example embodiments, the folding portion includes a biasing element (e.g., spring 106), the additional action including counteracting a force imparted by a biasing element.

The folding portion can include, for example, a blade holder subassembly and a blade securing component, the blade holder subassembly and the blade securing component being configured such that the blade holder subassembly is pivotally repositionable in relation to the blade securing component when the release member is actuated or triggered. In example embodiments, the blade holder subassembly and the blade securing component include complementary surfaces (such as, for example, the stop surfaces 116b and 116a and the blade holder subassembly 230 and the blade securing component 232, respectively) that come into contact limiting an amount that the blade holder subassembly can be pivoted away from the blade securing component during a blade change operation.

Referring to FIGS. 2, 5 and 6, in example embodiments, the housing (e.g., handle 108) includes or is provided with an engagement member (e.g., a protrusion, or other engagement surface or structure, such as the engagement member 166) that engages (a portion of) the blade securing component (such as the channel 165 of the left side folding portion 114a) to prevent the blade securing component from repositioning in relation to the housing (or resist such repositioning of the blade securing component) during a blade change operation.

In example embodiments, the pocket knife (or other tool) is configured such that in order to change the blade, the knife must be in a closed position. By way of example, a small sheet metal tab on the rear of the knife can be configured (e.g., in a manner described herein) such that when it is depressed, the right body half is able to be swung upward, exposing the blade. After the blade is reversed or changed, the body half can be slid shut.

In example embodiments, the pocket knife (or other tool) is configured such that the left side folding portion 114a can be withdrawn from the handle 108 and reengaged with (secured to) the right side folding portion 114b prior to the right side folding portion 114b being returned to its closed position within the handle 108.

Further with regard to the folding portions 114a and 114b (and other knife components), it should be understood that the portions/components herein also can be provided in mirror image versions for left-handed or alternative implementations.

Example embodiments of pocket knives and other tools include a circumferential guide having one or more portions (e.g., such as the curved track portions 164 and 170 shown in FIG. 6). In example embodiments, a circumferential guide can include a single track (e.g., a curved track portion) or multiple tracks or track portions. In example embodiments, a circumferential guide includes at least one curved portion, and may include one or more additional portions, continuous or discontinuous therewith, such as one or more of: an additional curved portion, a straight portion, a recess, and a guide portion (or feature) including a turn and/or a detent.

In example implementations, a pocket knife or tool can be provided with a blade securing component including a circumferential guide (such as, for example, the track 164 portion) configured to receive an engagement member (such as, for example, the engagement member 166). The housing/handle (of the pocket knife or tool) can include an additional engagement member (such as, for example, the engagement member 166 of the handle portion 161b; see FIG. 2) configured to engage the blade holder subassembly when the folding portion is in a closed position. The housing/handle (of the pocket knife or tool) can include a lock member (such as, for example, the engagement member 168; see FIG. 5) configured to secure the folding portion in the opened position and to reposition along the circumferential guide (such as, for example, the curved track 170 portion; see FIG. 6) as the folding portion is moved toward a closed position. In example embodiments, the engagement member and the lock member reposition along different portions of the circumferential guide respectively when the folding portion is being moved toward the closed position. In this example implementation, the blade securing component includes a tape splitter (e.g., integrally formed as shown).

Example embodiments of pocket knives and other tools include multiple folding portions (e.g., including a blade holder subassembly and a blade securing subassembly) and one or more engagements/interfaces between the folding portions. Referring to FIGS. 18 and 19, in this example, as previously discussed, the engagements/interfaces include surfaces of the folding portions 114a and 114b (e.g., surfaces defining and/or facilitating a circumferential interface) configured to reposition in relation to each other at a base portion of the knife (e.g., when the right side folding portion 114b is repositioned to a blade change position). The folding portions can include, for example, a blade holder subassembly and a blade securing subassembly configured such that the blade holder subassembly is pivotally repositionable in relation to the blade securing subassembly when the release member is actuated or triggered. In example embodiments, the subassemblies are configured such that surfaces of the subassemblies interface (e.g., reposition to face each other) at a base portion of the knife in a circumferential (nested) arrangement when the blade holder subassembly is repositioned to a blade change position. In example embodiments, the blade securing subassembly includes a stop surface (such as, for example, the stop surface 116a) against which a portion (such as, for example, the stop surface 116b) of the blade holder subassembly is brought into contact when moved to the blade change position. In example embodiments, the release member is engaged by a stop surface (such as, for example, the stop surface 116a) when the blade securing assembly is pivoted to a blade securing position (e.g., at which the subassemblies are locked together by said engagement of the release member and stop surface, the release member being driven by the lateral bias force to automatically detent into the opening preventing the blade holder subassembly from pivotally repositioning relative to the blade securing subassembly (independent of the position of the folding portion or whether it is in its closed position). In this example implementation, the folding portion subassemblies (when pivoted together and realigned) interfit such that the subassemblies automatically lock together independent of whether the folding portion is folded into the handle. In example embodiments, the blade holder subassembly and the blade securing subassembly include guards that are independently repositionable (in relation to the subassemblies respectively).

Thus, in an example embodiment, a pocket knife (or other tool) includes a housing (e.g., handle) and a folding portion coupled to and repositionable in relation to the housing, the folding portion including a release member (configured to be activated by a user of the knife) and a blade holder subassembly which is repositionable (in relation to the housing) when the release member is actuated or triggered to a blade change position at which a blade positioned on the blade holder subassembly is partially covered (to lessen the likelihood of the blade falling away from the blade holder subassembly) until an additional action is performed to reposition a component of the blade holder subassembly in relation to one or more other components of the knife and/or the folding portion thereof. The aforementioned component(s) of the blade holder subassembly (i.e., the component(s) repositioned in performing the additional action) can include a slider or other user repositionable component, or an assembly or subassembly, of or operatively connected to the knife and/or the folding portion thereof. In example embodiments, the component is a slider, and folding portion includes a biasing element (e.g., a spring) configured to impart a force upon the slider (that biases the slider to its retracted position), the folding portion being configured such that a user of the knife can perform the additional action (e.g., when the blade holder subassembly is in the blade change position) by repositioning (extending) the slider to counteract the force (imparted by the biasing element).

Although the present invention(s) has(have) been described in terms of the example embodiments above, numerous modifications and/or additions to the above-described embodiments would be readily apparent to one skilled in the art. It is intended that the scope of the present invention(s) extend to all such modifications and/or additions.

1-30. (canceled)

31. A pocket knife comprising:
a housing including an opening to a channel within the housing;
a blade carrier within the channel, the blade carrier including one or more actuator portions that permit a user of the knife to slide the blade carrier along the channel; and
a handle pivotally connected to the housing and configured to allow the housing to be pivoted away from the handle to an opened position, the handle including a biased engagement portion with a laterally extending protrusion that automatically locks the knife in the opened position until released.

32. The pocket knife of claim 31, further comprising:
a spring operatively connected between the blade carrier and the housing such that the blade carrier is biased along the channel toward a blade refracted position.

33. The pocket knife of claim 31, wherein the engagement portion engages a complementary portion of the housing to lock the knife in the opened position.

34. The pocket knife of claim 31, wherein the engagement portion engages a recessed portion of the housing that is not visible to a user of the pocket knife to lock the knife in the opened position.

35. The pocket knife of claim 31, wherein the engagement portion is integrally formed with an edge of the housing.

36. The pocket knife of claim 31, wherein the engagement portion is biased toward the housing by a portion of the handle that receives the housing when the housing is pivoted toward the handle.

37. The pocket knife of claim 31, wherein the housing includes a guide portion along which the engagement portion repositions when the housing is pivoted in relation to the handle.

38. The pocket knife of claim 37, wherein the guide portion includes a surface that faces the engagement portion when the housing is in a closed position providing a mechanical resistance to the housing being moved from the closed position.

39. The pocket knife of claim 31, wherein the one or more actuator portions include one or more cut guards.

40. The pocket knife of claim 39, wherein the one or more cut guards include a pair of cut guards.

41. The pocket knife of claim 40, wherein the cut guards are repositionable along opposites sides of the housing.

42. The pocket knife of claim 40, wherein the cut guards are received within the handle when the housing is folded to a closed position.

43. A pocket knife comprising:
a housing; and
a folding portion coupled to and repositionable in relation to the housing and configured for holding a blade;
wherein the housing is formed with an integral spring portion including a lock member that engages the folding portion locking the folding portion in an opened position.

44. The pocket knife of claim 43, wherein the lock member is not visible to a user of the knife.

45. The pocket knife of claim 43, wherein the integral spring portion defines an opening that receives the folding portion when the folding portion is repositioned to a closed position.

46. The pocket knife of claim 43, wherein the integral spring portion defines an edge portion of the housing, the edge portion being partially separated from the housing by a slot.

47. The pocket knife of claim 43, wherein the lock member extends laterally toward the folding portion.

48. The pocket knife of claim 43, wherein the integral spring portion is configured to bias the lock member toward the folding portion.

49. The pocket knife of claim 43, wherein the folding portion includes a guide portion along which the lock member repositions when the folding portion is pivoted in relation to the housing.

50. The pocket knife of claim 49, wherein the guide portion includes a surface that faces the lock member when the folding portion is in a closed position providing a mechanical resistance to the folding portion being moved from the closed position.

51. The pocket knife of claim 43, wherein the folding portion includes a pair of cut guards configured to locate within the housing when the folding portion is moved to a closed position.

52-68. (canceled)
